(19) United States
(12) Patent Application Publication
(10) Pub. No.: US 2013/0226757 A1
(43) Pub. Date: Aug. 29, 2013

(54) SYSTEMS AND METHODS FOR LIEN MANAGEMENT

(71) Applicants: Jeff Bouma, Scottsdale, AZ (US); William H. Stine, Scottsdale, AZ (US)

(72) Inventors: Jeff Bouma, Scottsdale, AZ (US); William H. Stine, Scottsdale, AZ (US)

(21) Appl. No.: 13/780,720

(22) Filed: Feb. 28, 2013

Related U.S. Application Data
(60) Provisional application No. 61/605,005, filed on Feb. 29, 2012.

(51) Int. Cl. G06Q 40/02

(52) U.S. Cl. CPC G06Q 40/02
USPC 705/35

(57) ABSTRACT

The present disclosure relates to lien management systems, methods and computer program products (collectively “systems”). The various systems are capable of interfacings with client systems (e.g., healthcare provider EMRs and billing systems) to identify and generate lien filings. These lien filings are verified (e.g., the digital documents are digitally signed and/or electronically notarized) and recorded. The systems also provide for lien tracking, notification, payment and release.

### CROSS REFERENCE TO RELATED APPLICATION

This application claims priority to U.S. Provisional Appl. No. 61/605,005, filed Feb. 29, 2012, the entire disclosure of which is incorporated herein by reference.

### FIELD

The present application relates to an integrated hardware-software system for capturing, preparing, validating, storing, monitoring and filing liens. More specifically, the present application relates to an automated medical lien generation, filing, tracking, storage and validation system.

### BACKGROUND

Traditionally, medical liens have been filed by hand or, at best, prepared by using computerized forms which are filled out, printed, signed and notarized by hand, delivered in person or by e-mail and then mailed to those required by law to be notified of the filed and recorded lien. Lien releases are traditionally done the same way. Traditional “wet” sealed and signed paper liens and releases require at least 2 and often 4 to 5 people to prepare, file, store and mail. This is expensive, time consuming and filled with mistakes because of a lack of standardization in preparation process and differing amounts of knowledge and expertise in understanding the requirements and applicability of lien law at the provider level.

### SUMMARY

In various embodiments, a lien management system is provided. The lien management system comprises an information capture engine in electronic communication with a preparation engine. The information capture engine is configured to access a client source and assess client data to identify lien filings. The information capture engine may capture the client data and transmits the client data to the preparation engine. The lien data may be rendered into a lien filing by the preparation engine. The preparation engine may be in electronic communication with a validation engine, such that the validation is configured to authenticate the lien filing. The validation engine may be in electronic communication with a memory and a filer. The lien filing may be stored in the memory and the lien filing may be filed by the filer.

### BRIEF DESCRIPTION OF THE DRAWINGS

The subject invention will hereinafter be described in conjunction with the appended drawing figures, wherein like numerals denote like elements, and wherein;

FIG. 1 is a block diagram depicting various system components of a lien management system, in accordance with various embodiments;

FIG. 2 is a block diagram depicting various system components of a lien management system couple with a client source, in accordance with various embodiments;

FIG. 3A is a block diagram depicting various system components of a lien management system configured with a client interface, in accordance with various embodiments;

FIG. 3B is a block diagram depicting various system components of a lien management system configured with a client interface, in accordance with various embodiments; and

FIGS. 4A-4F are illustrations of screenshots associated with various components of a lien management systems in accordance with various embodiments.

### DETAILED DESCRIPTION

The detailed description of exemplary embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

In various embodiments, the Lien Management System (“LMS”) may be an automated, paperless, identification, preparation, filing, storing, tracking, and mailing system designed that assists medical professionals, hospitals and other healthcare providers. The LMS can eliminate the need to manually identify, prepare, and file liens and lien releases for medical patients, and to streamline the process of securing a medical lien. The LMS can provide a permanent electronic storage and tracking system for all lien related transactions and can be instantly accessed by a user. The LMS may be configured to create notice letters and copies of recorded liens and releases. The LMS may communicate those documents to entities and/or individuals who are required by law to be notified.

In various embodiments, the LMS may comprise and use digital verification elements (e.g., encrypted digital signatures, digital notary certificates, and/or the like). These digital verification elements may be used to electronically sign, notarize, file retrieve, store and prepare liens for transmission and filing. Patient information may be entered into standardized forms manually. The LMS may automatically also retrieve and populate appropriate patient information by interfacing and retrieving data from an electronic medical record (EMR) system. In this way, the LMS may automatically create liens by retrieving and preparing the lien information directly from the health care provider's EMR.

The LMS may be in electronic communication with health care provider EMRs and billing systems. The link between the LMS and healthcare provider systems may allow the LMS to parse, evaluate and otherwise identify lien filings. The LMS may be configured to automatically generate a lien filing based on its evaluation of healthcare provider systems or may provide alerts to a user in response to lien filing being appropriate. For example, the LMS may generate a report that is presented to a user in response to activities associated with a patient being associated with a lien filing (e.g., an invoice associated with a patient bill being more than a certain number of days past due).

More specifically, access to the EMR and/or health care provider billing system may provide the LMS with the ability to identify medical and/or billing records associated with a patient that require lien filing. For example, the LMS also has the capability of conducting searches of billing records to identify appropriate cases and/or patients subject to lien filing. Moreover, the LMS may be capable of considering factors associated with a patient and/or billing record to determine whether the characteristics of the record are appropriate for lien filing based on predetermined or dynamically determined parameters. For example, the system may consider the total amount of outstanding invoices not paid for a certain period of time in response to a record being a certain number of days past due. Moreover, the LMS may consider a patient prior payment history over a period of time or may evaluate the patient payment history to identify a trend. The LMS may consider the value or total liability associated with a patient invoice and/or bill (e.g., the total collectable dollars associated with an invoice or unpaid bill) or another attribute such as the type of item provided (e.g., elective medical items versus medically required or recommended items).

In an exemplary embodiment, LMS may be configured to automatically store electronic versions of the signed, notarized and recorded liens in a user accessible database, in “PDF”, “TIFF” and/or other suitable formats. The database may be configured with security compliance with HIPAA requirements and/or other suitable confidential data storage requirements.

In an exemplary embodiment, the LMS may be configured with user access allowing a user to access a specific account and to view summaries of lien filing activity, as well as access and retrieve filed liens, lien releases and notification letters. These letters are automatically prepared for mailing and paired with the electronically filed and recorded liens by the LMS. The LMS may also be configured to transmit (e.g., e-mail) and or submit “PDF” and/or “TIFF” images of the recorded liens and releases, and notification letters to a user for final mailing or to file the lien documents through an application programming interface associated with a lien recordation service (e.g., a government maintain lien recordation service, a credit bureau, and/or the like).

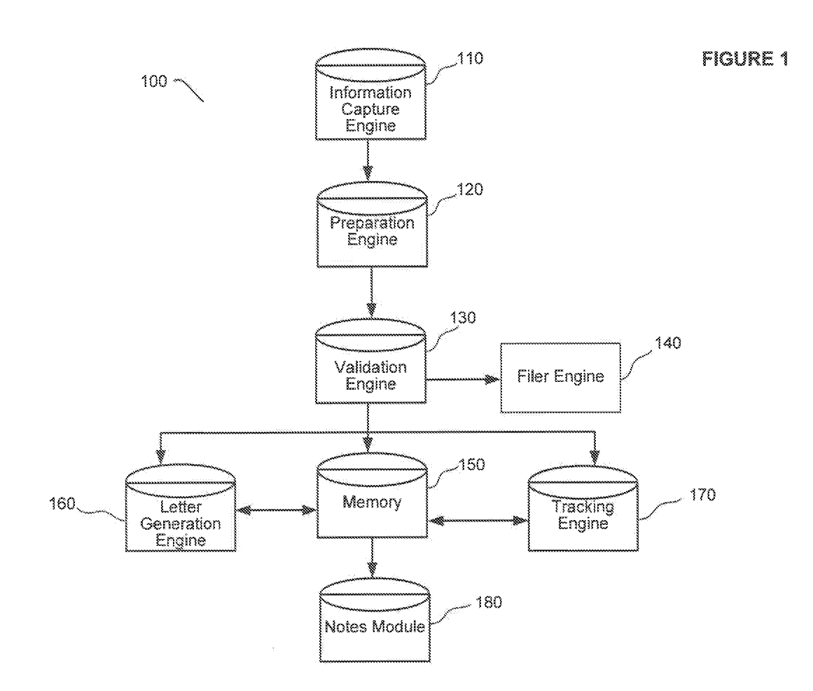

In various exemplary embodiments and with reference to FIG. 1, a lien management system 100 (“LMS 100”) may be a hardware or hardware-software system comprising an information capture engine 110, a preparation engine 120, a validation engine 130, a filer module 140, and a memory 150.

A “user” may include any individual or entity that interacts with a system (e.g., LMS 100) or participates in a process associated with LMS 100. A user may perform tasks such as creating, requesting, retrieving, receiving, updating, analyzing, entering and/or modifying data. A user may be, for example, be a healthcare provider, a doctor, an office manager, a customer, an administrator, a client, a manager, an employee and the like.

In various embodiments, LMS 100 can comprise a control interface, a user interface, a software module, a logic engine, numerous databases and/or computer networks configured to provide a user with access to lien records. While LMS 100 may contemplate upgrades or reconfigurations of existing processing systems, changes to existing databases and business information system tools are not necessarily required by the present invention. LMS 100 is configured to interface with any suitable EMR system and/or healthcare provider billing system.

In various embodiments and with continued reference to FIG. 1, information capture engine 110 may be any system or engine configured to access, recall, and/or capture patient data. In its various forms, information capture engine 110 includes user selectable and/or automated software. Information capture engine 110 may be capable of accessing, viewing, displaying, capturing, creating, recalling, and navigating patient data from a client source. Information capture engine 110 may be a software engine coupled to and/or accessible from a user interface or a similar system capable of accessing a network, such as for example, the Internet.

In various embodiments, preparation engine 120 may be any system or engine configured to receive, modify, manipulate, render, manage, and/or transmit patient data. Preparation engine 120 may be electrical communication with information capture engine 110. Preparation engine 120 may be configured to receive patient data collected by information capture engine 110. Further, preparation engine 120 may be configured to process, configure, and/or render data in a format appropriate for registration with a governmental agency responsible for recording, storing, and/or perfecting liens. The form a lien must take to be submitted to the appropriate governmental agency may take any form as required by the agency or statute.

In various embodiments, validation engine 130 may be any system or engine configured to receive, verify, validate, notarize, authenticate, or otherwise substantiate, and transmit data. Validation engine 130 may be in electrical communication with preparation engine 120. Validation engine 130 may be configured to audit data prepared and provided by preparation engine 120. Validation engine 130 may further be configured to authenticate data provided by preparation engine; such that the data is rendered in a form that complies with the validation and/or authentication rules of the recording governmental agency. Validation engine 130 may be capable of securing and/or verifying a document with a digital signature, digital notarization, and/or other digital verification. The document being verified (e.g., an electronic document) may be coded or modified to show verification. For example, where the document is coded the metadata or attributes of the document may be modified to indicate that the document has been verified. Where the document is visual modified, the digital document may include a digital stamp or seal that is visible to a user.

Filer module 140 may be any system or engine configured to receive, and transmit data. Filer module 140 may be in electronic communication with validation engine 130. Filer module may also be in electronic communication with a governmental agency recordation system (not shown). As such, filer module 140 may be configured to receive authenticated data from validation engine 130 and subsequently transmit authenticated data to a governmental agency recordation system. The type of data being transmitted may require encryption or other security measures such that it complies with data transmission requirements for a particular type of data, such as, for example, HIPAA regulations and the specific electronic filing requirements of the region, state, or county were the lien is to be electronically filed.

In various embodiments, memory 150 may be any data storage medium. Memory 150 may be any stationary or portable electronic storage medium. Memory 150 may be in electronic communication with validation engine 130. Validation engine 130 may transmit authenticated data to memory 150 for storage and retrieval by a user. Memory 150 may also be in electronic communication with filer module 140. Filer module 140 may transmit authenticated data to memory 150 for storage and retrieval by a user.

In various embodiments and with continued reference to FIG. 1, LMS 100 may further comprise a letter generation engine 160. Letter generation engine 161) may be any system capable of automatically, capturing, formatting, and preparing lien data in a reporting letter and rendering the letter in a format required for lien notification. Letter generation engine 160 may be in electronic communication with memory 150 and/or validation engine 130. Letter generation engine 160 may be configured to receive data from validation engine 130 and create a lien reporting letter. Thereafter, letter generation engine 160 may address, print, and/or otherwise transmit the letter to a party to be notified when a lien is filed. Further, letter generation engine 160 may be configured to create an electronic image of the letter in “PDF”, “TIFF”, and/or other suitable format, such that the electronic image may be transmitted to memory 150.

In various embodiments, LMS 100 may further comprise a tracking engine 170. Tracking engine 170 may be any software or hardware-software system configured to monitor and collect information pertaining to a lien. In an exemplary embodiment, tracking engine 170 may be coupled to memory 150. Tracking engine 170 may be configured to assess the status of a lien, and transmit data to a memory 150 for storage.

Tracking engine 170 may also be configured to collect and/or aggregate lien data. The aggregated data may be presented to a user. For example, tracking engine 170 may be configured to track and present the number of outstanding liens associated with an account, the number of filed liens associated with an account, the number of in process liens associated with an account, the number of released liens associated with an account, and/or the like.

In various embodiments, LMS 100 may further comprise a notes module 180. Notes module 180 may be any system capable of receiving, storing, and associating a user input with a particular lien file or series of lien files. Notes module 180 may comprise a text file or other suitable file for tracking and capturing user notes. Notes module 180 may also be capable of graphically associating notes (e.g., a text file) with a particular electronic lien document or series of electronic lien documents. Moreover, the associated notes may be accessible by a user in response to a lien associated with the notes file being selected. Notes module 180 may also comprise access preferences that may be defined by the user creating the note. These preferences may limit access to certain notes based on a user level, user type, and/or any other suitable categorization. Notes module 180 may be in electronic communication with a memory 150, such that a user input can be entered in notes module 180 and stored in memory 150.

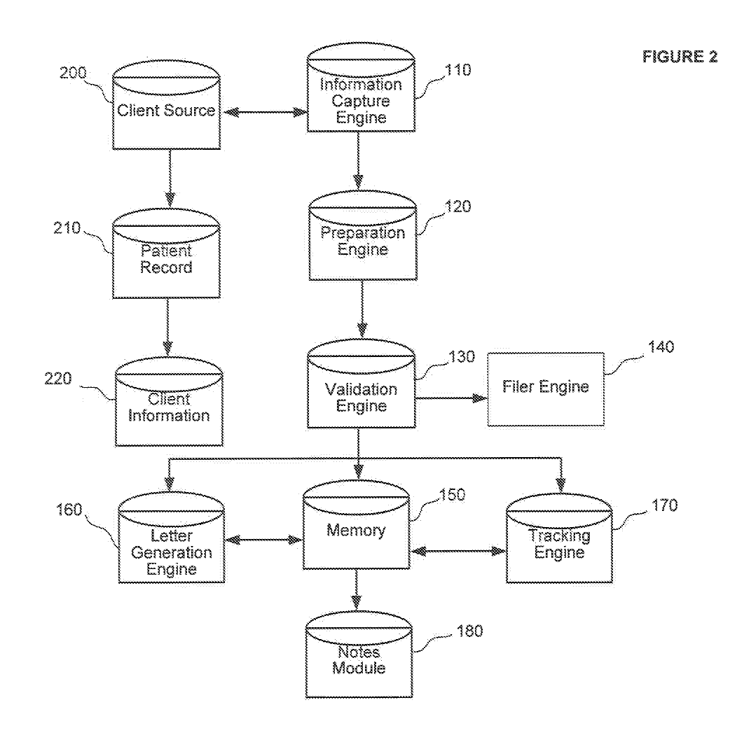

In various embodiments and with reference to FIG. 2, LMS 100 may be coupled to a client source 200. Client source 200 may comprise a patient record 210 and client information 220. Client source 200 may be any Client source 200 may be in electronic communication with information capture engine 110. Information capture engine 110 may be configured to access client source 200 and analyze patient record 210 to determine whether a lien should be filed given the details of patient record 210. Further, information capture engine 110 may be configured to access client information 220. As such, information capture engine 110 may be configured to associate client information 220 with patient record 210 in the event that the need for a lien is identified by information capture engine 110.

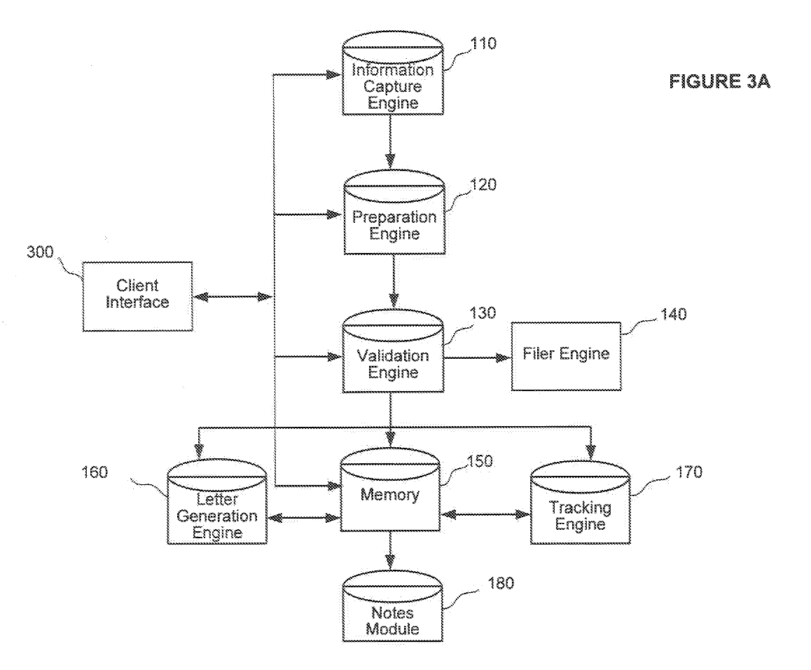

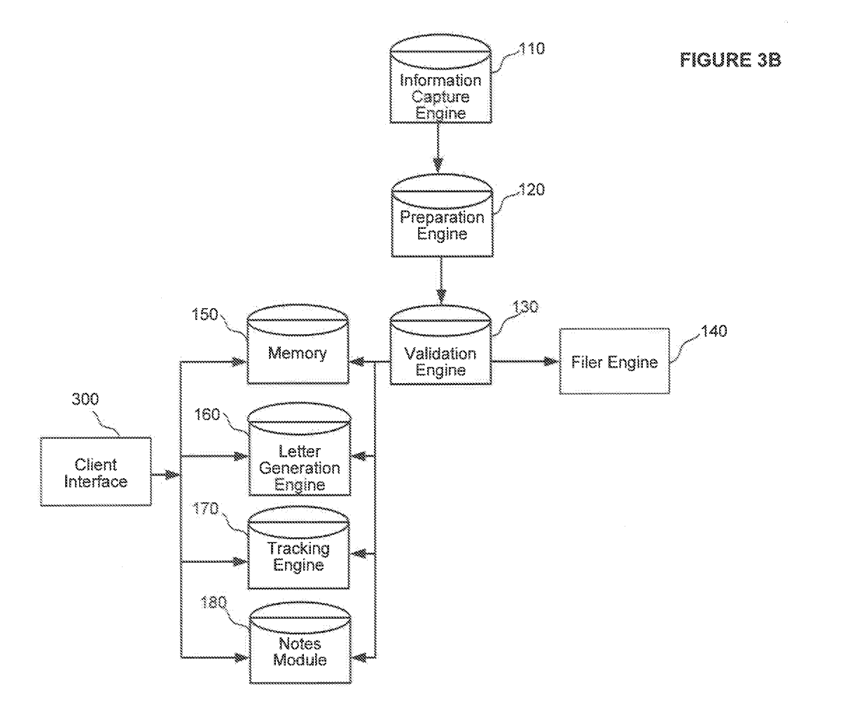

In various embodiments and with reference to FIG. 3A and FIG. 3B, LMS 100 may be in electronic communication with client interface 300. Client interface 300 may be any software or hardware-software system configured to provide a user with access to LMS 100 and display lien data. In an exemplary embodiment, lien management system may be in electronic communication with at least one of information capture engine 110, preparation engine 120, validation engine 130, memory 150, letter generation engine 160, tracking engine 170, and/or notes module 180. Client interface 300 may be configured to access an engine or module of LMS 100 and display information associated with a specific lien or series of lien to a user. For example, in an exemplary embodiment, client interface 300 may be in electronic communication with tracking engine 170. Client interface 300 may be configured to access tracking engine 170, display the number of liens associated with a particular user, display the total value of the liens outstanding and/or collected, and display the total number of liens that have been released.

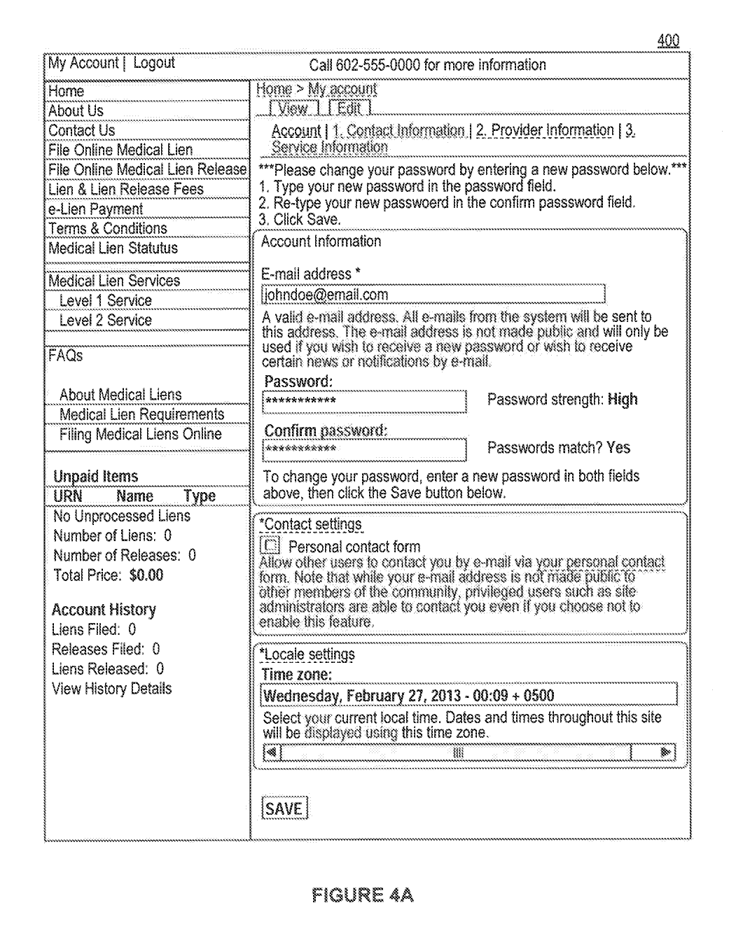

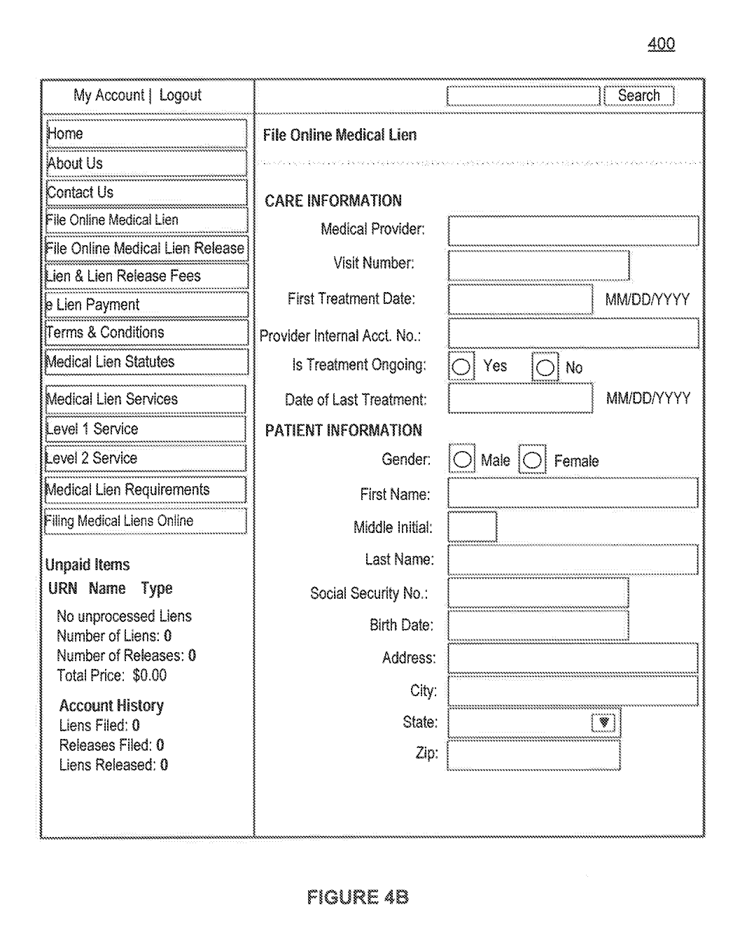

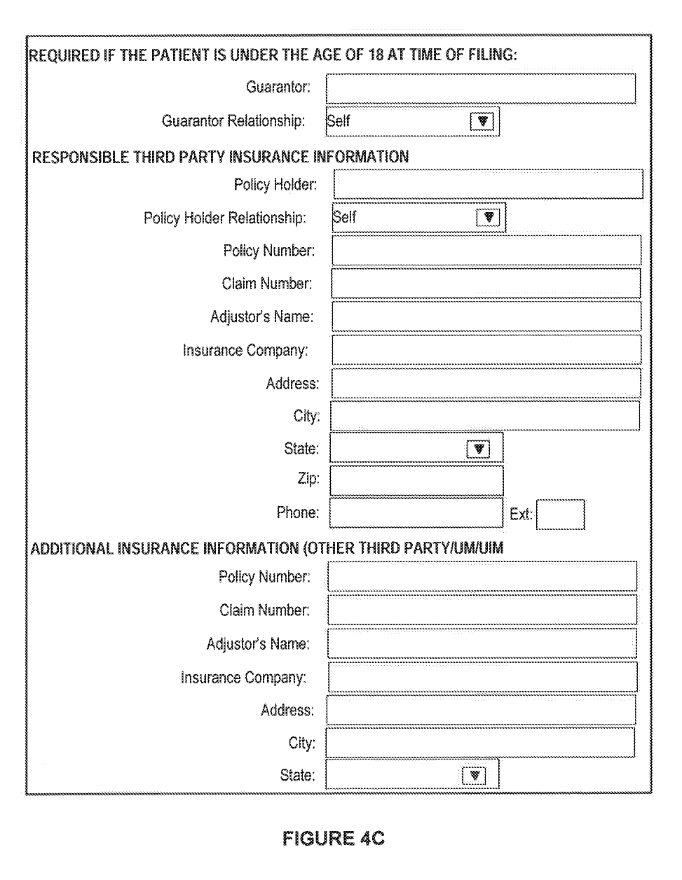

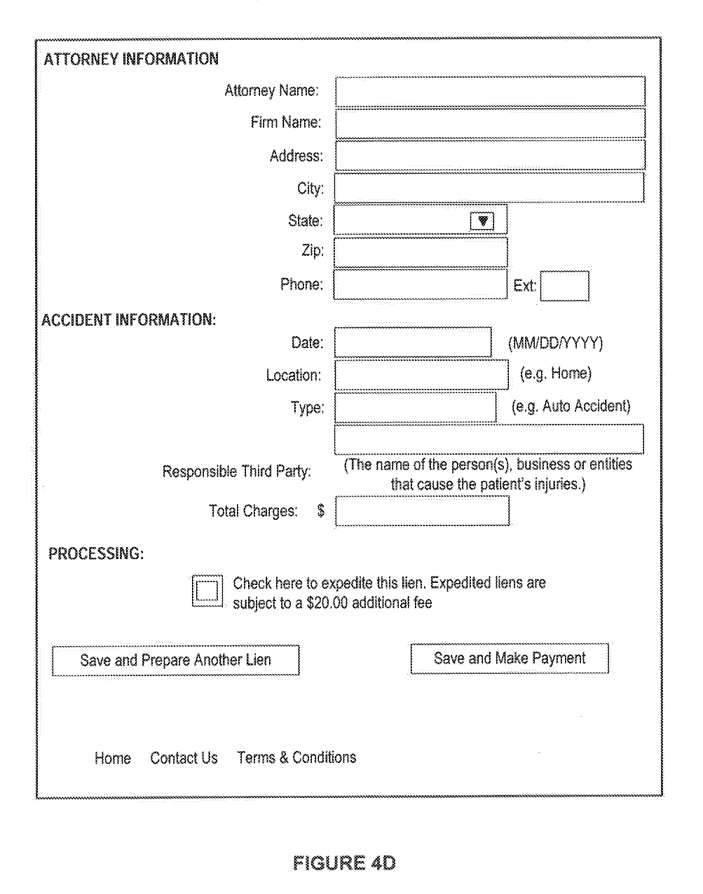

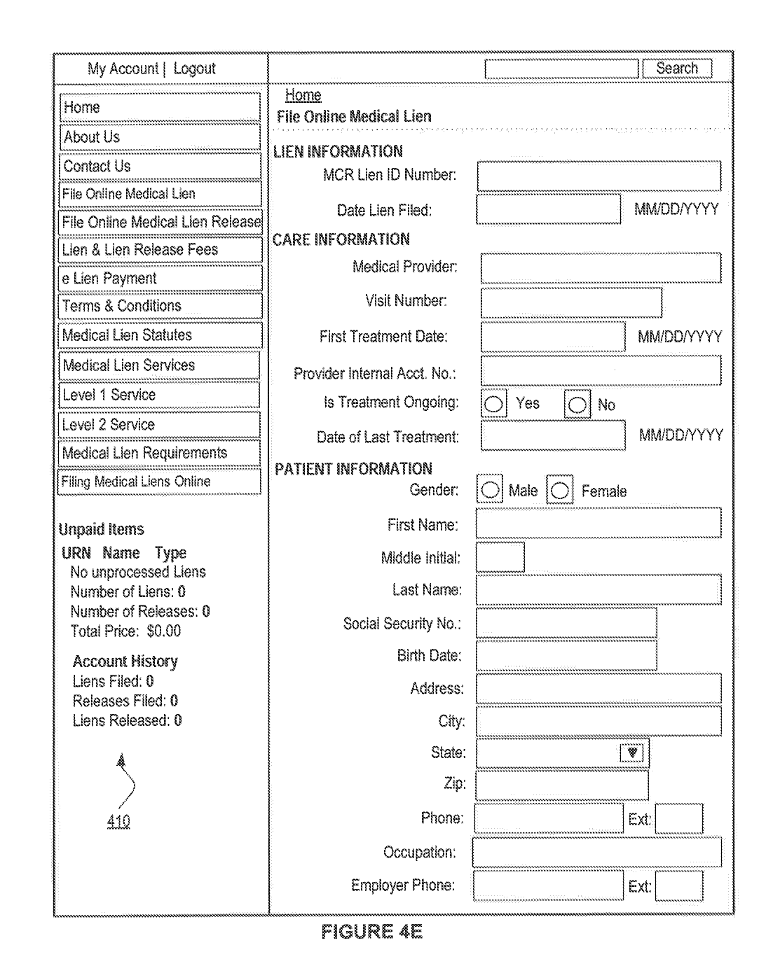

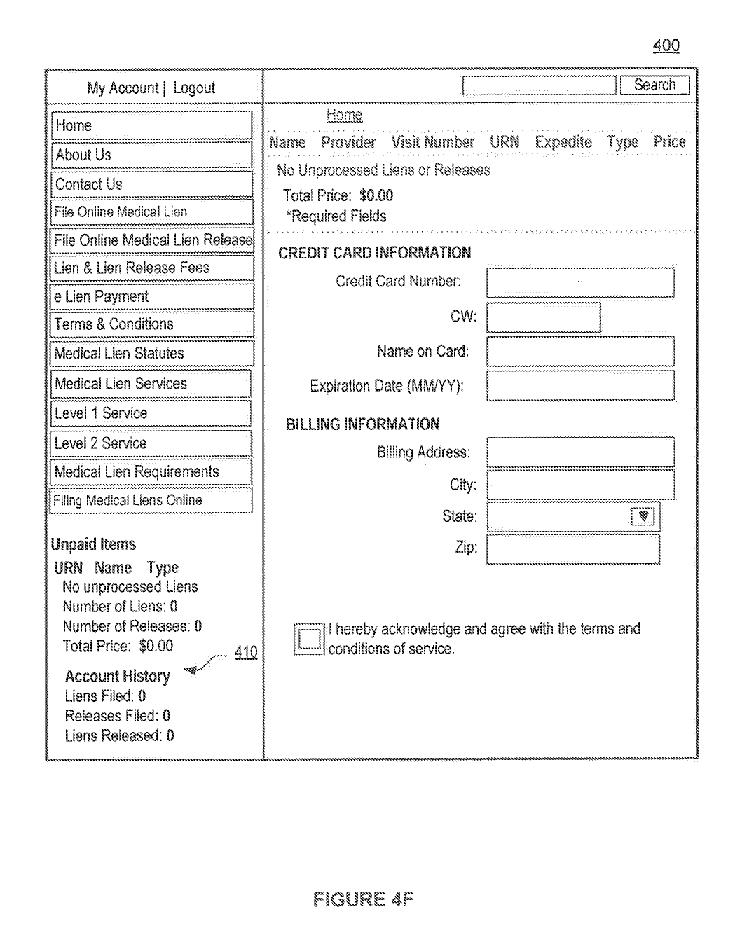

In various embodiments and with reference to FIGS. 4A-4F, LMS 400 may be accessible to a user through any suitable portal. For example, LMS 400 may comprise a login in page as shown in FIG. 4A, that allows a user to access LMS 400. The system may further comprise a security protocols. For example, access to LMS 400 through a portal may require a user to enter a username and password. For increased protection, LMS 400 may set a time limit on a particular password associated with a username. In response to the password expiring, the user may request a new password by providing the username to LMS 400 through the portal. LMS 400 may generate a new password or a selectable link and transmit that link or password to a user. The user may then access or re-establish a password to access LMS 400.

In various embodiments, a user may provide, subject (e.g., patient-debtor) information for a lien filing. This may be done by completing a tillable form or by providing subject identifying information as illustrated in FIG. 4B-4D. Where the user provides the initial information via a fillable form, the user inputs are parsed by LMS 400 from the form to create the lien documents. Where the user provides subject identifying information, LMS 400, via information capture engine 110 and/or preparation engine 120, may contact or and capture information from a healthcare provider system (e.g., an EMR and/or billing system) to obtain additional information to complete the lien application. LMS 400 may require any suitable kind of information including, for example, patient information, healthcare provider information, party-responsible for payment information, insurance information, attorney information, injury/accident information, and the like to complete the lien for filing.

In response to a lien being complete, based on user provided data and/or data captured from a healthcare provider system, LMS 400 may certify or verify (e.g., electronically sign and/or notarize) the lien for filing. LMS 400 may transmit or otherwise file or record the verified lien with an appropriate government entity.

In response to the recordation and/or the receipt of a certified copy of the lien from a recording entity, LMS 400 may create a notification of the lien that is transmitted to the patient-debtor. This notification may be an automatically generated letter that is created based on the information provided by the user and/or captured by LMS 400 for the healthcare provider system.

LMS 400 may also be capable of releasing a medical lien. As shown in FIG. 4E, when the debt associated with the lien is satisfied a user may trigger a release. The user may provide release information or trigger the system to contact the healthcare provider system to obtain information regarding satisfaction of the lien. This release information may be used by LMS 400 to create a lien release. LMS 400 may file the release against the recorded lien as appropriate to release the lien.

LMS 400 may comprise a payment terminal as shown in FIG. 4F. The payment terminal may be accessed by a user. The user may be a patient-debtor or party-responsible for payment that has been notified of a lien filing as described herein. Payment and lien identifying information may be provided to LMS 400, in response to the payment and lien information being provided, LMS 400 may trigger a lien release action and filing to satisfy and otherwise release the lien.

As described herein, LMS 400, through tracking engine 170, may monitor and report lien filing, payment and release activities. Tracking engine 170 may make this information accessible to a user that access LMS 400. For example, LMS 400 may be configured with a lien dashboard 410. This dashboard may be user selectable such that all of the lien information associated with a user account is interactively selectable by the user. In this way, the user may monitor lien filings or take an action associated with a specific lien through lien dashboard 410.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs).

Implementation of the hardware state machine so as to perform the functions described herein will be apparent to persons skilled in the relevant art(s).

In various embodiments, the server may include application servers (e.g. WEB SPHERE, WEB LOGIC, JBOSS). In various embodiments, the server may include web servers (e.g. APACHE, IIS, GWS, SUN JAVA SYSTEM WEB SERVER).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as iPads, iMACs, and MacBooks, kiosks, terminals, point of sale (POS) devices and/or terminals, televisions, or any other device capable of receiving data over a network. A web-client may run Microsoft Internet Explorer, Mozilla Firefox, Google Chrome, Apple Safari, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In an exemplary embodiment, access is through a network or the Internet through a commercially-available web-browser software package.

As those skilled in the art will appreciate, a web client includes an operating system as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In an exemplary embodiment, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, components, modules, and/or engines of LMS 100 may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device, online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein.

The various system components may be independently, separately or collectively suitably coupled to the network via data links which includes, for example, a connection to an Internet Service Provider (ISP) over the local loop as is typically used in connection with standard modern communication, cable modem. Dish networks, ISDN, Digital Subscriber Line (DSL), or various wireless communication methods. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand.

As used herein, “transmit” may include sending electronic data from one system component to another over a network connection. Additionally, as used herein, “data” may include encompassing information such as commands, queries, files, data for storage, and the like in digital or any other form.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the user, business rules, or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, GPG (GnuPG), and symmetric and asymmetric cryptosystems.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within an web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server, Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WebSphere MQTM (formerly MQSeries) by IBM, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data. structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. §101.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment. C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A lien management system, comprising:
a processor;
a tangible, non-transitory memory configured to communicate with the processor;
an information capture engine configured to access a client source and assess a client data to identify a lien filing;
a preparation engine in electronic communication with the information capture engine, wherein the preparation engine is configured to receive the client data from the information capture engine and prepare the lien filing;
a validation engine in electronic communication with the preparation engine, wherein the validation engine is configured to authenticate the lien filing; and
a filer module in electronic communication with the validation engine, wherein the lien filing is stored in the memory and the lien filing is flied by the filer.

2. The system of claim 1, further comprising a tracking engine configured to monitor the status of the lien filing and display information associated with the lien filing.

3. The system of claim 1, further comprising a letter generation engine in electronic communication with the validation engine is configured to create and communicate a document associated with the lien filing.

4. The system of claim 1, wherein the client source is at least one of an EMR and a billing system.

5. The system of claim 4, wherein the information capture engine access at least one of the EMR and the billing system in response to a user request.

6. The system of claim 4, wherein the user provides the user request through a portal associated with the system and the request comprises patient information to trigger a lien generation.

7. The system of claim 1, wherein the validation engine is configured to modify at least one of the attributes of a digital document and an image of the digital document.

8. The system of claim 7, wherein the document is associated with a lien filing and is generated by the preparation engine in response data from the client source satisfying criteria associated with the lien filing.

9. The system of claim 1, wherein the system comprises a lien filing portal, a lien release portal and a payment portal.

10. A method, comprising:
accessing, by a computer based system for managing medical liens, a client source and assess a client data to identify a lien filing;
receiving, by the computer based system, client data from a client source to associated with a lien filing;
authenticating, by the computer based system, the lien filing with a digital certificate; and
filing, by the computer based system, the lien filing with an agency associated with a jurisdiction in response to the authenticating.

11. The method of claim 10, further comprising:
monitoring, by the computer based system, a status of the lien filing; and
displaying, by the computer based system, information associated with the lien filing.

12. The system of claim 10, further comprising creating, by the computer based system, a notification associated with the lien filing.

13. The system of claim 10, accessing, by the computer based system, the client source in response to a user request, wherein the client source is at least one of an EMR and a billing system.

14. The system of claim 13, wherein the user provides the user request through a portal associated with the computer based system and the request comprises patient information to trigger a lien generation.

15. The system of claim 10, further comprising, modifying, by the computer based system, at least one of the attributes of a digital document and an image of the digital document, wherein the digital document is generated in response to a user request to create a lien filing.

16. The system of claim 10, wherein the computer based system comprises a lien filing portal, a lien release portal, and a payment portal.

17. An article of manufacture including a non-transitory, tangible computer readable storage medium having instructions stored thereon that, in response to execution by a computer-based system for managing medical liens, cause the computer-based system to perform operations comprising:
accessing, by the computer based system, a client source and assess a client data to identify a lien filing;
receiving, by the computer based system, client data from a client source to associated with a lien filing;
authenticating, by the computer based system, the lien filing with a digital certificate; and
filing, by the computer based system, the lien filing with an agency associated with a jurisdiction in response to the authenticating.

18. The method of claim 17, further comprising:
monitoring, by the computer based system, a status of the lien filing;
displaying, by the computer based system, information associated with the lien filing;
creating, by the computer based system, a notification associated with the lien filing.

19. The system of claim 17, accessing, by the computer based system, the client source in response to a user request, wherein the client source is at least one of an EMR and a billing system, wherein the user provides the user request through a portal associated with the computer based system and the request comprises patient information to trigger a lien generation.

20. The system of claim 17, further comprising, modifying, by the computer based system, at least one of the attributes of a digital document and an image of the digital document, wherein the digital document is generated in response to a user request to create a lien filing.
